(19) United States
(12) Patent Application Publication
(10) Pub. No.: US 2007/0181136 A1
(43) Pub. Date: Aug. 9, 2007

(54) Oral appliance

(76) Inventor: Michael L. Gelb, Hartsdale, NY (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/350,152

(22) Filed: Feb. 8, 2006

(51) Int. Cl. A61C 5/14

(52) U.S. Cl. 128/859

(57) ABSTRACT

An oral appliance including a flexible sheet having opposite faces and an edge surrounding the faces, a protrusion extending from at least one of the faces of the flexible sheet, and a notch formed in the edge of the flexible sheet.

### BACKGROUND OF THE INVENTION

The present invention relates to an oral appliance, and more particularly an oral application for alleviating tension and stress, thereby preventing headache and neck ache in a user.

As evidenced by high volume sales of various pain relief medications for headache and neck ache, it is apparent that there is a need for reducing these conditions. In fact, headaches alone are estimated to cost our society 40 billion dollars and 550 million lost work days in a year. Tension and stress are blamed for approximately ninety percent of all reported headaches and neck aches. And, the majority of these headaches and neck aches originate in the jaw and neck muscles. The problem is exacerbated by stress levels, which can cause gritting, clenching, and grinding of the teeth, both day and night.

Most people are unaware of proper positioning for their jaw and teeth. They assume their jaw should be closed and their teeth touching. However, this positioning causes tension and stress in the jaw and neck, along with overall discomfort. Additionally, gritting, clenching, and grinding of the teeth can result in broken, misshapen teeth or damaged enamel.

### SUMMARY OF THE INVENTION

Briefly, the present invention includes an oral appliance comprising: a flexible sheet having opposite faces and an edge surrounding the faces; a protrusion extending from at least one of the faces of the flexible sheet; and a notch formed in the edge of the flexible sheet.

In another aspect, the invention includes an oral appliance for placement in a mouth of an user. The appliance comprises a flexible sheet adapted to be positioned behind teeth of the user. The sheet has opposite faces and an edge surrounding the faces. Further, the appliance includes a protrusion extending from at least one face of the flexible sheet for positioning between the teeth of the user when the flexible sheet is positioned behind the teeth of the user. The appliance also comprises a notch formed in the edge of the flexible sheet for positioning a tongue of the user against a palate of the user's mouth.

A method of the present invention for alleviating tension and stress in a user includes placing an appliance between teeth of a user to space the teeth, and positioning a tongue of the user against a palate of the user using the appliance.

Other features of the present invention will be in part apparent and in part pointed out hereinafter.

### BRIEF DESCRIPTION OF THE DRAWINGS

FIG. 1 is a front elevation of an oral appliance according to the present invention.

FIG. 2 is a side elevation of the oral appliance.

FIG. 3 is a cross section of the appliance positioned inside the mouth of a user taken in the plane of line 3-3 in FIG. 1.

FIG. 4 is a front elevation of the appliance positioned inside the mouth of a user.

Corresponding reference characters indicate corresponding parts throughout the several views of the drawings.

### DETAILED DESCRIPTION OF THE PREFERRED EMBODIMENT

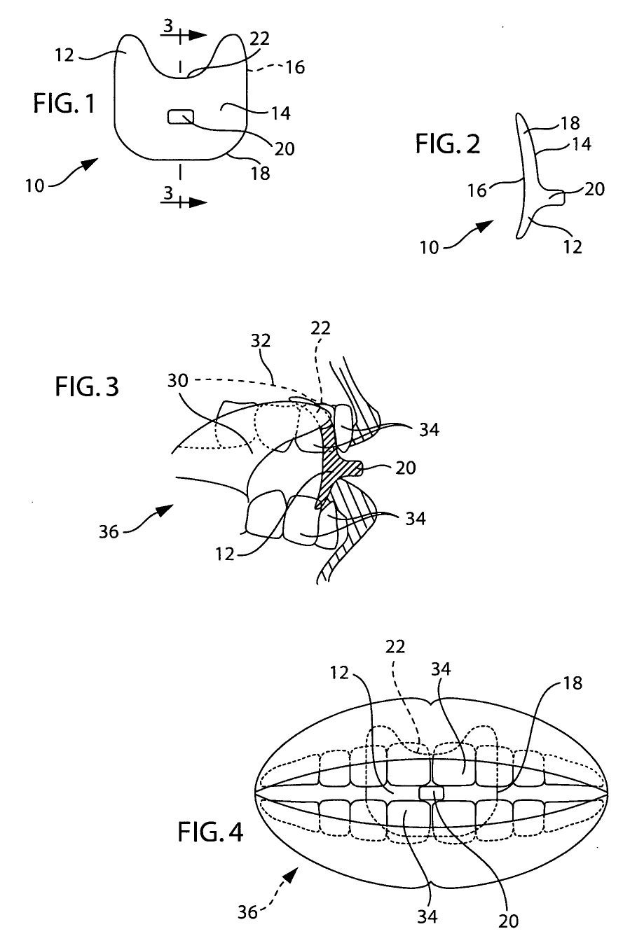

Referring now to the drawings and in particular to FIG. 1, an oral appliance of the present invention is designated in its entirety by the reference numeral 10. The oral appliance 10 is intended for alleviating headache and neck ache. The oral appliance 10 includes a flexible sheet 12 having opposite faces 14, 16 and an edge 18 surrounding the faces. In one embodiment, a protrusion 20 extends from one face 14. Further, the sheet 12 has a notch 22 along a portion of the edge 18 for positioning a tongue 30 of a user adjacent to a palate 32 of the user.

The flexible sheet 12 is adapted to fit behind teeth 34 of the user, as shown in FIGS. 3 and 4. To facilitate a proper fit behind the teeth 34, the flexible sheet 12 may be modified to accommodate the physical characteristics of the user. Although the sheet 12 may have other dimensions without departing from the scope of the present invention, in one embodiment, the sheet has a height of between about 18 millimeters and about 30 millimeters, a width of between about 19 millimeters and about 31 millimeters, and a thickness of between about 8 millimeters and about 12 millimeters. In one particular embodiment, the sheet 12 has a height of about 24 millimeters, a width of about 20 millimeters and a thickness of about 9 millimeters. Although the height, width and thickness characteristics may vary, in one embodiment the height, width and thickness taper as shown. In other embodiments (not shown), the height, width and thickness are uniform and do not taper or otherwise vary. Further, in one embodiment, edges and corners of the sheet 12 are rounded to provide enhanced comfort to the users. In some instances, such as depicted in FIG. 3, when the oral appliance 10 is placed inside a mouth 36 of the user, the flexible sheet 12 is bent so it extends rearward away from the upper teeth 34 of the user and over the user's palate 32. As will be appreciated by those skilled in the art, the flexibility of the sheet 12 enables it to bend and adapt to the shapes and contours of the user's mouth 36.

As further illustrated in FIG. 1, the notch 22 is formed in an upper edge of the of the sheet 12. The notch 22 approximates a shape of a forward portion of the user's tongue 30 to encourage the user to position the tip of his or her tongue against the palate 32. Although the notch 22 may have other shapes without departing from the scope of the present invention, in one embodiment the notch is generally circular and has a width of between about 12 millimeters and about 16 millimeters, and a depth of between about 8 millimeters and about 12 millimeters. In one particular embodiment, the notch 22 has a width of about 14 millimeters and a depth of about 10 millimeters. Although the protrusion 20 and notch 22 may be spaced by other distances without departing from the scope of the present invention, in one embodiment, the protrusion and notch 22 are spaced by a distance of between about 8 millimeters and about 14 millimeters. In one particular embodiment, the protrusion 20 and notch 22 are spaced by a distance of about 10 millimeters.

As illustrated in FIG. 2, the protrusion 20 is integrally formed with the sheet 12 so it extends from one face 14. Although the protrusion 20 may have other dimensions without departing from the scope of the present invention, in one embodiment, the protrusion has a length of between about 3 millimeters and about 6 millimeters, a width of between about 4 millimeters and about 8 millimeters, and a thickness of between about 2.5 millimeters and about 4 millimeters. In one particular embodiment, the protrusion 20 has a length of about 5 millimeters, a width of about 5 millimeters and a thickness of about 3 millimeters. Although the length, width and thickness may vary, in one embodiment the length, width and thickness are generally uniform and do not taper or otherwise vary. Although the appliance 10 may be made of other materials without departing from the scope of the present invention, in one embodiment the sheet is molded from a flexible material such as a pliable polymer or medical grade silicone. Further, in one embodiment the appliance 10 is molded in one piece for manufacturing convenience and durability. Further, in some applications the flexible sheet 12 may be favored or scented. For instance, mint may be used to aid in digestion or relief of the common cold. Or, a lavender scent may be used to promote calm and relaxation.

FIGS. 3 and 4 depict the oral appliance 10 of the present invention inserted and positioned in the mouth 36 of the user. The oral appliance 10 can be manufactured in a wide range of sizes based on the characteristics of the mouth 36 of the user. However, it is envisioned that a limited number of sizes could accommodate most users. FIG. 3 illustrates that the entire the oral appliance 10 fits into the mouth 36 of the user so the protrusion 20 extends between and separates the teeth 34. Further, the notch 22 positions the user's tongue 30 against his or her palate 32. It is believed separating the teeth 34 and positioning the tongue 30 against the palate 32 promotes relaxation and reduces stress. It is further believed that separating the teeth 34 and position the tongue 30 in this manner reduces the potential for headache and neck ache resulting from stress. Separating the teeth 34 keeps the user from closing his or her jaw in a tensed position and placement of the tongue 30 adjacent to the palate 32 relaxes the jaw, throat and neck muscles.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made, in the above constructions without departing from the scope of the invention, it is intended that all matter contained in the above description or shown in the accompanying drawings shall be interpreted as illustrative and not in a limiting sense.

What is claimed is:

1. An oral appliance comprising:
a flexible sheet having opposite faces and an edge surrounding the faces;
a protrusion extending from at least one of the faces of the flexible sheet; and
a notch formed in the edge of the flexible sheet.

2. An appliance as set forth in claim 1 wherein the flexible sheet is adapted to fit behind teeth of a user and extend at least partially over a palate of the user.

3. An appliance as set forth in claim 1 wherein the notch positions tongue of the user adjacent the palate of the user.

4. An appliance as set forth in claim 1 wherein the protrusion has a thickness of between about 2.5 millimeters and about 4 millimeters.

5. An appliance as set forth in claim 4 wherein the thickness of the protrusion is about 3 millimeters.

6. An appliance as set forth in claim 1 wherein the protrusion has a width of between about 4 millimeters and about 8 millimeters.

7. An appliance as set forth in claim 6 wherein the width of the protrusion is about 5 millimeters.

8. An appliance as set forth in claim 1 wherein the protrusion and the notch are spaced by a distance of between about 8 millimeters and about 14 millimeters.

9. An appliance as set forth in claim 8 wherein the distance by which the protrusion and the notch are spaced is about 10 millimeters.

10. An appliance as set forth in claim 1 further comprising a flavoring agent.

11. An appliance as set forth in claim 1 further comprising a scent.

12. An oral appliance for placement in a mouth of an user comprising:
a flexible sheet adapted to be positioned behind teeth of the user, said sheet having opposite faces and an edge surrounding the faces;
a protrusion extending from at least one face of the flexible sheet for positioning between the teeth of the user when the flexible sheet is positioned behind the teeth of the user; and
a notch formed in the edge of the flexible sheet for positioning a tongue of the user against a palate of the user's mouth.

13. An appliance as set forth in claim 12 wherein the flexible sheet extends away from the teeth of the user and over a palate of the user when the protrusion is positioned between the teeth.

14. An appliance as set forth in claim 12 wherein the protrusion has a width of between about 4 millimeters and about 8 millimeters.

15. An appliance as set forth in claim 14 wherein the width of the protrusion is about 5 millimeters.

16. An appliance as set forth in claim 12 wherein the protrusion and the notch are spaced by a distance of between about 8 millimeters and about 14 millimeters.

17. An appliance as set forth in claim 16 wherein the distance by which the protrusion and the notch are spaced is about 10 millimeters.

18. An appliance as set forth in claim 12 further comprising a flavoring agent.

19. An appliance as set forth in claim 12 further comprising a scent.

20. A method of alleviating tension and stress in a user comprising:
placing an appliance between teeth of a user to space the teeth; and
positioning a tongue of the user against a palate of the user using the appliance.
